(19) United States
(12) Patent Application Publication
(10) Pub. No.: US 2008/0169245 A1
(43) Pub. Date: Jul. 17, 2008

(54) Solids separation technology

(75) Inventors: Aicardo Roa-Espinosa, Green Bay, WI (US); Michael Dennis Krysiak, Green Bay, WI (US)

Correspondence Address: WEISS & WEISS, Suite 251, 300 Old Country Road, Mineola, NY, 11501, US

(73) Assignee: SOIL NET LLC.

(21) Appl. No.: 11/654,186

(22) Filed: Jan. 17, 2007

(51) Int. Cl. C02F 1/56

(52) U.S. Cl. 210/734; 210/731; 210/725; 210/738; 210/767

(57) ABSTRACT

A method for separating a low biosolids suspension stream into biosolids and water whereby the biosolids contain the majority of the original beneficial nutrients, and the water is substantially free of components harmful to the environment is disclosed. The method relies on the use of a coagulant and a flocculent to bind the colloidal particles and a rotating screen drum separator. Examples detail a composition of manure stream treated with specific coagulant and flocculent that achieve high separation efficiencies and speeds. A composition for binding colloidal fines using a coagulant and flocculent in several industrial uses is also disclosed.

### BACKGROUND OF THE INVENTION

1. Field of the Invention

The present invention relates generally to the fields of handling and treating low solids suspensions and separating the solids from the liquids. More specifically, it concerns chemical compositions, methods and apparatus for separating organic colloidal suspensions into a clean water component and a high solids component, and recovering the beneficial minerals and nutrients of the suspension by utilizing a combination of chemical treatment and mechanical separation techniques. In other embodiments of the invention, these compositions, methods and apparatus are used to clean industrial effluents from impurities and toxins. More specifically yet, the present invention concerns chemical compositions, methods and apparatus for separating a waste manure stream from farm operations into a solids component and a water component.

2. Description of Prior Art

A. Separating Solids from a Liquid or Solid Suspension

The use of chemicals for binding colloidal fines and solids in a suspension is well known in the art. U.S. Pat. No. 3,994,806 discloses a composition comprising a 5 to 20 percent aqueous solution of a mixture of dimethyl diallyl ammonium chloride homopolymer and polyacrylamide in a weight ratio of from 10 to 1 to 20 to 1. In the flocculation and removal of suspended matter from water, combinations of cationic and nonionic water-soluble polymers are found to be more effective than equivalent concentrations of cationics alone, and significantly lower concentrations of the combination are found to be equivalent in effect to higher concentrations of cationic polymers alone. U.S. Pat. No. 4,931,190 is directed to a method for dewatering thin slurries of very fine clay or clay-like material to yield high solids content filter cake, for example, 40% solids and greater, by the use of flocculating agent combinations involving polyethylene oxide-type flocculating agents and polyacrylamide-type flocculating agents. The method generally involves admixing the combination of flocculating agents with the slurry, dewatering the slurry by means of a mechanical dewatering apparatus and feeding the thickened slurry to a belt press filter. U.S. Pat. No. 5,213,693 teaches a novel composition comprising a dry blend of the two polymers that can be formed to provide a combined solution for mixing with a suspension. The composition is used on sewage sludge and other organic suspensions for filter press or belt press dewatering by substantially simultaneous treatment with a cationic coagulant polymer and a cationic flocculent polymer. In U.S. Pat. No. 5,846,433, a suspension is dosed with a coagulant and then with a flocculent and is dewatered to form a thickened sludge or cake and separated liquor, and control of the dewatering performance is improved by adding the flocculent at a predetermined dosage, monitoring the charge in the separated liquor (or monitoring other dewatering parameter of the separated liquor or suspension) and adding coagulant at a dosage selected in response to the monitored charge or other parameter value in order to maintain the value substantially at a pre-selected optimum value. U.S. Pat. No. 6,805,803 discloses a process of flocculating and dewatering an aqueous suspension of suspended solids comprising (a) a concentrated polymer solution and, (b) a dilute polymer solution, characterized in that the concentrated and dilute polymer solutions are introduced into the substrate substantially simultaneously. Preferably the concentrated and dilute polymer solutions are introduced into the suspension as an aqueous composition comprising a dilute aqueous solution of polymer and a concentrated solution of polymer. The process brings about improvements in filtration and cake solids.

B. Separating Solids from Liquid Manure

Manure is hazardous to humans, animals and the environment. Untreated manure, typically containing animal feces and urine, is a perfect medium for the proliferation of microbes and parasites. Manure also emanates gases produced by decomposition such as hydrogen sulfide, methane, ammonia, and carbon dioxide. These gases do not only produce a foul smell, but, in high enough concentrations, each of these gases may pose a health threat to humans and livestock. Manure runoffs also pose a contamination threat to rivers, streams and groundwater.

Farms have several options for manure management: solid material handling, slurry handling, liquid manure handling, treatment in an anaerobic lagoon, composting, and a combination of these. One of the more common management practices is to collect the manure in large lagoons or digesters where the manure is treated with anaerobic bacteria that digest organic matter by liquefying it and then converting it primarily into carbon dioxide, methane, ammonia, and hydrogen sulfide. The manure, typically between 1% to about 5% solids, and most typically to about 2% solids, is relatively easy to handle and can be disposed of in crop field irrigation. The manure can also be handled by using conventional irrigation equipment and without the need to use special pumps. Disposal through irrigation normally carries a low risk of contaminating the ground water in situations where the soil is sufficiently thick to filter out these contaminants before reaching the ground water. Slurry manure, i.e. manure with a solids content of about 5% to about 7%, is more difficult to handle and requires special pumps and irrigation equipment.

There are several disadvantages to using liquid manure in this fashion, however. 1) The valuable nutrients and minerals in the manure are not being effectively utilized, 2) It requires expensive storage and handling equipment, 3) A large quantity of water is locked in with the manure and can not be beneficially used, 4) In northern states the ground is frozen during the winter months and irrigation can not be used to dispose of the liquid manure since it would cause runoffs that could contaminate rivers and streams and 5) Ground water contamination can occur where the soil is not very effective in filtering out the contaminants contained in the stream.

Manure is a foul smelling mixture of about 98% water and 2% solids. The solids portion contains valuable nutrients and minerals most notably phosphates and nitrates suspended in a colloidal state. It would be therefore desirable to recover these components for use in fertilization and to release clean and usable water.

Attempts to separate manure solids material from liquids in the past included mechanical means, chemical means or a combination of the two. Mechanical separation means alone proved to have low separation efficiency as the colloidal fines tend to stay with the liquid portion. Combinations of mechanical and chemical separation methods have had more success but generally required slow and expensive multiple batch floatation stages in order to achieve the required high separation efficiencies.

U.S. Pat. No. 6,749,068 describes a separation process using a sloped screen of small openings and using air flow to enhance liquid drainage. U.S. Pat. Nos. 5,205,930 and 6,651,822 are directed toward a mechanical separator pressing the solids using a screw feeder. U.S. Pat. No. 5,268,100 discloses liquid slurry introduced at a top in-feed end of the screen and moved downwardly along the in-feed section of the screen by a paddle conveyor. Separation of solids occurs primarily along the in-feed screen section. The slurry is then moved angularly upwardly along the discharge section of the screen for final dewatering.

Chemical additives used to effect the agglomeration of particles onto solids material were coagulant flocculent chemicals known in the art such as aluminum sulfate, calcium hydroxide, calcium carbonate, calcium sulfate, anionic polymers, and cationic polymers such as polyacrylamide. For example, U.S. Pat. No. 4,079,003 teaches the use of longitudinally spaced paddles for moving and agitating a mixture, particularly when the minimum solids concentration is in excess of 25%, so as to achieve an agglomeration of solids into a solid friable material, largely as a result of large quantities of lime to generate heat and cause dehydration and solidification. U.S. Pat. No. 5,401,402 discloses a method of treating sewage sludge, in which the sludge is mixed with an alkaline material in such a way as to provide intimate surface contact that enables the alkaline material to permeate even small particles of the sludge, and to deliver the resultant product in a granular form. The sludge and alkaline material are delivered to a mixing chamber and are confronted therein with a screw type mixer having generally helical flighting carried by a shaft, with the mixer being rotatably driven in generally horizontal arrangement to convey the mixture toward an outlet. U.S. Pat. No. 6,824,691 discloses a process for treating liquid manure with a tertiary or quaternary polyacrylamide in an amount of between 80 ppm and 140 ppm and stirring for a time ranging from 5 to 15 minutes to flocculate the colloidal suspension onto the solids. The solids are separated from the liquid by floatation. U.S. Pat. Nos. 5,785,730 and 5,776,350 disclose a method for separating raw agricultural waste into a liquid portion and a nutrient enriched solids portion by adding an effective amount of a quaternized amino methylated polyacrylamide polymer, mixing the polymer with the raw agricultural waste, subjecting the mixture to at least one mechanical separation means, and separately collecting the liquid and the solids portions. Pre-grant publication No. 20050000906 discloses a method of treating animal manure using a biological passive flotation step in a flotation unit having a hydraulic residency time (HRT) of about 4 to about 24 hours with a polymer followed by a skimming means for removing floating solids from at least a portion of the surface of the manure. This is followed by a secondary floatation and skimming step having a residence time of 0.5-4 hours. The claims of the publication are directed to the use of a polymer with the preferred embodiment of a polyacrylamide. Pre-grant publication No. 20060108291 teaches a method of treating manure comprising: a) mixing a quantity of manure with lime such that said mixture has a basic pH; b) adding a first coagulating polymer to said mixture, thereby promoting floc formation within said mixture; c) separating the floc from the mixture, thereby forming solids and a liquid portion; d) adding a second coagulating polymer and/or a struvite-promoting compound to said liquid portion, thereby forming solids and clear liquid; and e) separating the clear liquid from the solids.”

### Terminology

The invention disclosed in this application involves the removal of water from suspensions containing colloidal fine particles that results in a high solids portion and water that contains a very small amount of these particles. In the art and in the specification for this application, the source suspension may be referred to as: low solids suspension, colloidal suspension, liquid suspension, solids suspension, particles suspension, low biosolids suspension, or dilute suspension. In the case of manure, the source suspension may be referred to as manure, liquid manure, low solids manure, manure slurry, or simply “manure”. The solids resulting from the separation may be referred to as biosolids, solids component, solids, manure solids, or low moisture solids as the case may be. Agglomeration is an action by which small colloidal particles coalesce into larger size particles. Agglomeration relates to particle size enlargement, particle joining or particle binding. An effective mechanism to achieve this is by the addition of a coagulant and a flocculent to a particles suspension. Coagulation is the process by which the electrical repulsion between individual particles is reduced, inverted, or neutralized. Flocculation is used to describe the action of polymeric materials which form bridges between individual particles. Bridging occurs when segments of a polymer chain adsorb on different particles and help the particles agglomerate into larger particles. Flocculants have charged groups with a charge that counterbalances the charge of the particles. Flocculants adsorb on the particles and cause destabilization by bridging and/or charge neutralization. The joining and enlargement of these particles continues for as long as the flocculent is present and the system charge favors bridging.

### SUMMARY OF THE INVENTION

The present invention relates to a chemical composition for the agglomeration of colloidal suspension particles into solids. This composition is a combination of a coagulant and a flocculent that is effective for liquids that comprise organic colloidal solids in the range of about 0.5% to about 30%. When applied in proper dosages, water that is substantially free of these particles is released, and solids, that contain all the beneficial elements of the suspension such as nutrients and minerals, can be easily and speedily separated from the water by mechanical means. The separation provides solids that can be used to take advantage of these beneficial elements, and water that is substantially free of these elements that can be used for industrial purposes or, with additional treatment, can be made potable. The chemical composition is effective in a variety of applications such as cellulose, ethanol bi-products, manure, sugar cane, grain distilled ethanol, and switch grass.

It is an object of the present invention for the coagulant and flocculent to work on contact to separate the solids from the liquids.

It is an object of the present invention for the system and process to work on the separation of solids and liquids in municipal sewage sludge.

The present invention also relates to a method for separating a solids suspension, and more specifically an organic colloidal suspension, comprised of the steps of 1) applying a chemical composition to treat the colloidal suspension particles to agglomerate them into a solids component and to release water from the suspension, 2) separating continually the water from the solids, and 3) moving continually the water and solids apart from each other.

The steps for continually separating water from the biosolids and moving the water apart from the solids can be accomplished by a variety of mechanical separation devices. These include conveyor paddles, flighted conveyors, stationary sloping screen, a cyclone separator, gravity based separators, piston separators, vibrating screens, belt press, roller press, shaftless spiral conveyors, or rotating screens. The preferred embodiment for a mechanical separation device is a rotating screen combined with a flighted screw ribbon arrangement that allows progressive thickening of the solids suspension through the length of the screw housing while the water drains through the screens and moves the thickened solids towards the exit.

This method constitutes a significant improvement in separation speed relative to the prior art while utilizing relatively low cost equipment and chemicals, and achieving high separation efficiency. Processing speeds in excess of 400 gal/min, and separation efficiency of over 98% can be achieved. This means that over 98% of the beneficial nutrients can be recovered in the biosolids and over 98% of the solids can be removed from the water effluent.

The present invention relates to a method for separating liquid manure into a solids component and water.

It is an object of this invention to provide compositions, methods and apparatus suitable for cleaning industrial effluents and bodies of water from impurities and toxins. Examples of uses for this technology are: cleaning river water from sediments, cleanup of PCBs from rivers, cleanup of water from domestic uses such as pools, hot tubs and fish tanks, and cleaning rivers and ground water of fertilizer residue.

It is an object of the present invention to provide manure biosolids suitable for land application for use as a fertilizer with or without the use of Water Soluble Polyacrylamides to stabilize the soil and its nutrients against erosion, crusting and to minimize water runoff. The biosolids must be chemically stable during the separation process and in handling, but able to break down and release the minerals and nutrients to the soil after the application.

It is an object of the present invention to provide a separation system of manure solids from water that is continuous and able to proceed at a rapid rate. It is further the object of the present invention to provide a water of potable quality as the product of the separation from manure. It is further the object of the present invention to provide the water effluent product of this separation that is substantially devoid of harmful bacteria to humans, livestock or the environment. It is further the object of this invention to provide biosolids that are devoid of any unpleasant smells.

It is an object of the present invention to provide a secondary water treatment method that allows further water clarification.

It is an object of the present invention to be able to correct the pH of the system by adding additives, for instance, calcium which would raise the pH.

It is an object of the present invention to provide the system to treat a polluted or dirty water system. An example of such a system is a pond which has too much sediment floating in it, or too much fertilizer free floating in the water. The system and process of the present invention can be used like a filter system, the dirty water, or water with contaminants in it is pumped from the body of water to the system of the present invention, wherein clean water is returned to the body of water. This same system can be used to assist in treating PCBs in a body of water.

In a preferred embodiment of this invention, two chemical mechanisms are combined to agglomerate the colloidal suspension particles together and to release water that is relatively free of solids: coagulation and flocculation. Coagulation is the destabilization of colloids by neutralizing the forces that keep them apart. Cationic coagulants provide positive electric charges to reduce the negative charge, or zeta potential, of the colloids. As a result, the particles collide to form larger particles referred to as flocs. Flocculation is the action of polymers to form bridges between the flocs and bind the particles into large agglomerates or clumps. Bridging occurs when segments of the polymer chain adsorb on different particles and help particles aggregate. An anionic flocculant will react against a positively charged suspension, adsorbing on the particles and causing destabilization either by bridging or charge neutralization. In order to effectively flocculate a colloidal suspension, a very high molecular weight polymer, typically greater than 1 million is required. Inter-particle bridging can occur with nonionic, cationic or anionic polymers. Both coagulation and flocculation reactions take place as soon as the chemicals make contact with the suspended particles and are virtually instantaneous. It is to be understood that effective coagulants or flocculants could perform well in and of themselves, however, when combined there is an enhanced synergistic effect.

Many factors determine the effectiveness of coagulation and flocculation. Among these are the nature and charge of the colloidal particles, the length, charge and shape of the polymer chain, and the ionic character of the solution.

The combination of flocculants and coagulants added to a solids suspension accomplishes three functions: 1) the agglomeration of colloidal particles into solids, 2) the release of the water from the suspension and 3) retention of the ionic components such as phosphates, nitrates, sulfates, potassium ions, and sodium ions. To a great extent flocculants alone can accomplish the separation of solids and water function fairly effectively. The addition of coagulants, however, makes the separation of the ionic particles and their retention onto the solids more effective.

Bivalent cationic oxides and salts are known inorganic coagulants. Examples are calcium chloride, calcium nitrate, calcium sulfate, magnesium chloride, magnesium nitrate, magnesium sulfate, calcium oxide and magnesium oxide. Trivalent cationic oxides and salts perform more effectively than bivalent oxides and salts. Among these are aluminum oxide, aluminum sulfate, aluminum chlorohydrate, aluminum perchloride and ferric chloride. Among the known organic coagulants are quaternary polyamines and PolyDADMAC.

Flocculants are hydrophilic polymers having a molecular weight varying from 1 to 30 million and a degree of polymerization of between 14,000 and 420,000 monomer units. Flocculants are typically acrylamide based. They may be homopolymers and have a nonionic nature or they may be copolymers and have a cationic or anionic nature with a degree of ionization varying between 0 and 100%.

Anionic flocculants are obtained either by hydrolysis of the amide groups on a polyacrylamide chain or by copolymerization of the polyacrylamide with a carboxylic or sulfonic acid salt. The most common type of flocculant made by copolymerization is one between an acrylamide and acrylic acid.

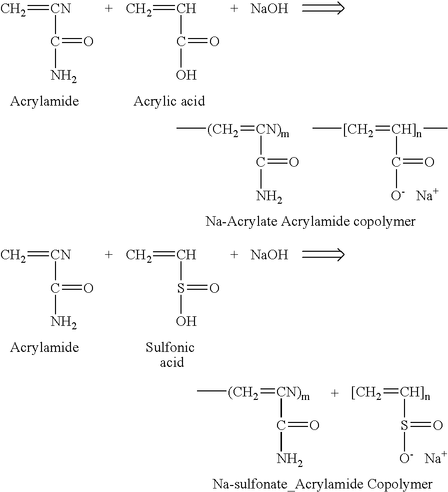

The anionicity of these copolymers can vary between 0% and 100% depending on the ratio of the monomers involved.

The main characteristics of the copolymers are:

Molecular weight: 3 to 30 million

Viscosity at 5 g/l: between 200 and 2800 cps.

Cationic flocculants are mainly derived from the copolymerization of acrylamide with dimethylaminoethyl acrylate (DMAEA) in quaternized form.

A first reaction of DMAEA with methyl chloride allows it to be converted into a quaternary ammonium salt in the form of chloromethylated DMEA (DMAEA-MeCI):

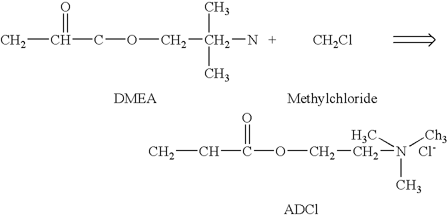

The copolymerization of DMAEA-MeCl with acrylamide produces the cationic polymer

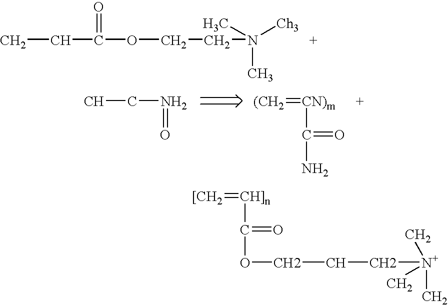

The cationic charge of the copolymer is determined by the ratio of each monomer and may vary between 0 and 100%.

The ester group of the copolymer is very sensitive to a pH of above 6.0: Pol-COOH₂CH₂N⁺Me₃+OH⁺ [symbol] Pol-COO⁻+HOCH₂N⁺Me₃

Hydrolysis of the polymer reduces its efficiency by creating amphoteric polymers and then anionic polymers. It is therefore essential to prepare these polymers at a pH of about 5.5, even though the flocculation is carried out at a higher pH. However, during flocculation, the floc may be converted by chemical modification of the polymer when the contact times are long, for example during settling.

The main characteristics of the products obtained are: molecular weights ranging from 3 to 10 million, and the viscosity at 5 g/l ranges from 100 to 1700 cps.

Processing manure in the present invention involves pumping the liquid manure from a lagoon or an anaerobic digester, mixing the liquid manure in line with an effective amount of a coagulant and/or an effective amount of a flocculent and then introducing the liquid manure into a mechanical separation device. A number of designs could be used. These include conveyor paddles, flighted conveyors, stationary sloping screen, a cyclone separator, gravity based separators, piston separators, vibrating screens, belt press, roller press, shaftless spiral conveyors, or rotating screens.

The preferred separation device embodiment for the purpose of this invention is a rotating screen combined with a flighted screw ribbon arrangement that allows progressive thickening of the manure through the length of the screw housing while the water drains through the screens and moves the thickened manure towards the exit. At the exit, the manure must be thick enough, i.e., at least 25% solids, so that it can be dewatered further by a compressing device such as a press roll, or a belt press. The rotation of the screen provides for the continuous exposure of new screen slots that increases water removal rates and reduces the likelihood of plugging. In the preferred embodiment, the water is drained through slotted screens located at the bottom of the flighting screw housing. The size of the screens can range from about 250 microns to about 4 mm, with the preferred range being about 500 microns to about 1 mm. It is important that the screens be flat and not made of wire for water drainage to be effective. The screen housing is tilted about 5 degrees to about 20 degrees upward to the direction of flow depending on the consistency of the incoming manure. The tilt allows balancing the flow of the solids and the removal of the water through the screens. The manure entering the separation device can be processed in a range from about 0.5-30% solids, however the more typical range is from about 1-5% solids. The manure typically exits the rotating screen housing at about 25-30% solids. It can be further dewatered to around 40-60% solids by pressing with a roller or by other compressing devices.

In the typical separation process, the coagulant and flocculent are each dissolved in a water makeup tank each at a concentration of about 1 g/Kg of water, or about 0.1%, and pumped into the manure separation device. They can be mixed in and pumped from either separate tanks or mixed together and pumped from the same makeup tank. The coagulant should be dissolved in a slightly acidic environment in a pH range of about 6-6.5 preferably using a weak organic acid such as citric acid, and the flocculant dissolved at an ionic strength of 25%. Where a pH adjustment to >7.0 is required for the flocculent, Calcium Oxide can be used.

A multitude of embodiments are disclosed comprising a coagulant and flocculent combination for manure treatment selected from the following list of coagulants and flocculants. It is to be understood that this list is not exhaustive and other coagulants and flocculants may be used in the context of the present invention.

### Inorganic Coagulants

### Aluminum Chlorohydrate (Al₃CHOH₅ClOH),

Aluminum sulfate,

### Aluminum Perchloride

### Aluminum Chloride

### Aluminum Nitrate

### Ferric Chloride

Calcium oxide
Magnesium oxide
Aluminum oxide
Ferric oxide
Calcium chloride
Calcium nitrate
Calcium sulfate
Magnesium chloride
Magnesium nitrate
Magnesium sulfate

### Organic Coagulants

### Polyamines

### PolyDADMAC

### Cationic Flocculants

Acrylamide/acryloylethyltrimethylammoniumchloride, or AM/AETAC by short notation,
Acrylamide/acrylamidopropyltrimethylammonium chloride or AM/APTAC, and
3-chloro-2-hydroxypropyltrimethylammonium chloride modified starch

### Anionic Flocculants

Acrylamide/sodium acrylate at pH >7
The sodium salt of Acrylamide/2-acrylamidomethylpropanesulfonic acid in the pH range of about 2-12.

The application levels of the coagulant can range from about 1-100 mg/liter of liquid manure, with a preferred range of about 5-50 mg/liter of liquid manure. The application level for the flocculent can range from about 5-75 mg/liter of liquid manure with the preferred range of about 20-50 mg/liter of liquid manure.

Solids separation performance is also enhanced by the addition of fiber to the liquid manure. This fiber provides additional surface area for colloidal particles flocculation. Preferred fibers are straw, bedding, and recycled manure solids and the addition level should range from about 0.5%-5% of liquid manure weight. Performance is likewise enhanced by recycling about 0.5%-5% of the biosolids into the solids separation device.

The water removed from the process typically has less than about 1% solids and with substantially reduced microbe levels compared to the liquid manure. The unpleasant odor of the original manure is also virtually completely neutralized by the chemical treatment. This water, while not potable, is suitable for most agricultural and industrial uses such as irrigation and manufacturing of chemicals. The water can be made potable, however, by further treatment with flocculants in a clarifier.

### BRIEF DESCRIPTION OF THE DRAWINGS

FIG. 1 shows a sketch of the process components for separating liquid manure.

### DETAILED DESCRIPTION OF THE DRAWINGS

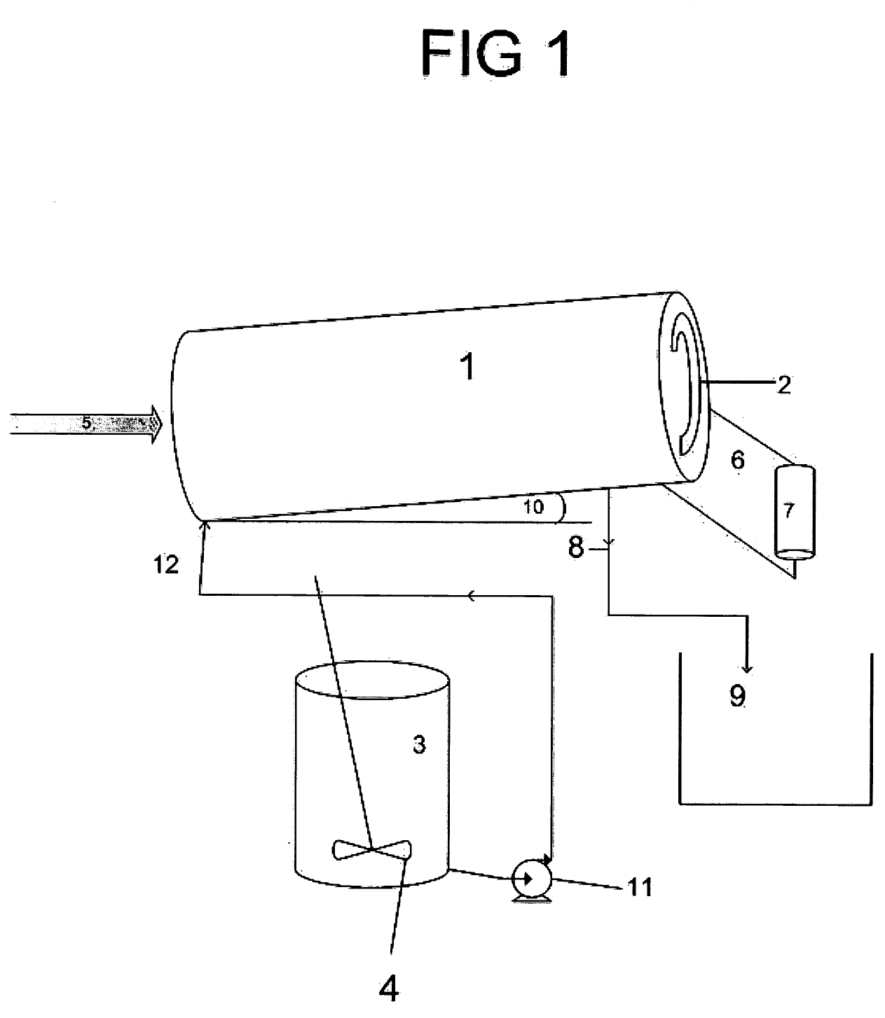

FIG. 1 is a schematic showing the components and the flow of the process. The colloidal suspension feed (5), which may be liquid manure or other such suspensions as described in this application, is pumped into the separation device (1) and is blended with the chemical feed (12). The chemicals are made up in a tank (3) using a mixer (4), and conveyed into the separation device by pump (11). The separation device (1) is a rotating drum having an angle of elevation (10) of about 5-20 degrees relative to horizontal. The bottom of the drum has screen portions through which the water drains (8) into collection tank (9), and a flighting ribbon (2) used for moving the progressively thickened solids to the exit of the separation device (1). The solids exiting the separation device (1) drop onto a hopper (6) from which they are fed under a roll press (7) that further removes water from the solids.

We claim:

1. A method for the continuous separation of water from a solids suspension comprising:
treating said solids suspension with an effective particle binding chemistry to agglomerate the solids suspension and form a solids component and a water component;
releasing said water component from said solids component by gravity; and
moving said solids component continually by a non compressing device away from the water component.

2. The method of claim 1, wherein said particle binding chemistry comprises a flocculent.

3. The method of claim 1, wherein said particle binding chemistry comprises a flocculent and a coagulant.

4. The method as in any one of claims 2 or 3, in which the flocculent is selected from the group consisting of Acrylamide/acryloylethyltrimethylammoniumchloride, 3-chloro-2-hydroxypropyltrimethylammonium chloride modified starch, Acrylamide/acrylamidopropyltrimethylammonium chloride, Acrylamide/sodium acrylate and the sodium salt of Acrylamide/2-acrylamidomethylpropanesulfonic acid or combinations thereof.

5. The method of claim 3, wherein the coagulant is selected from the group consisting of Aluminum Chlorohydrate, Aluminum sulfate, Aluminum Perchloride, Ferric Chloride, Polyamine, PolyDADMAC, Calcium Chloride, Calcium Nitrate, Calcium Sulfate, Magnesium Chloride, Magnesium Nitrate, Magnesium Sulfate, Aluminum Chloride, Aluminum Nitrate, Calcium Oxide, Magnesium Oxide, Aluminum Oxide and Ferric Oxide or combinations thereof.

6. The method of claim 1, wherein said solids suspension comprises organic waste bi-product materials.

7. The method as in claim 6, in which said organic waste bi-product materials include cellulose, bio-ethanol, sugar cane, grain distilled ethanol, manure, switch grass, and combinations thereof.

8. The method as in any one of claims 3 or 5, in which the coagulant is added in an amount of about 1-100 mg. per liter of the solids suspension.

9. The method of claim 8, in which the coagulant is added in an amount of about 5-50 milligrams per liter of the solids suspension.

10. The method as in any one of claims 2 or 3, in which the flocculent is added in an amount of about 5-75 milligrams per liter of the solids suspension.

11. The method of claim 10, in which the flocculent is added in an amount of about 20 to about 50 milligrams per liter of the solids suspension.

12. The method of claim 3, in which the flocculent and coagulant are mixed in a prescribed amount together or separately in a tank system equipped with proper agitation.

13. The method of claim 1, wherein the non compressing device for moving the solids is a rotating drum screen outfitted with ribbon flighting elements to convey the solids out of the drum.

14. The method of claim 1, wherein the non compressing device for moving the solids is a mechanical separation device selected from the group consisting of conveyor paddles, flighted conveyors, stationary sloping screens, cyclone separators, gravity based separators, piston separators, vibrating screens, belt presses, roller presses, shaftless spiral conveyors, and rotating screens.

15. The method of claim 13 wherein the rotating drum is tilted at an angle of elevation of about 5-20 degrees.

16. The method of claim 13, wherein the water drains by gravity through a flat screen of a size between about 250 microns and about 4 mm.

17. The method of claim 16, wherein the water drains through a flat screen of a size between about 500 microns and about 1 mm.

18. The method of claim 6, in which said organic material is manure.

19. The method of claim 18, further comprising about 0.5%-5% by manure weight of fiber additives to improve retention of the colloidal particles including straw fibers, bedding fibers, recycled manure solids, and combinations thereof.

20. The method as in any of claims 13 or 14, in which the solids exiting said non-compressing device contain between about 70% to 80% water.

21. The method as in any of claims 2 or 3, in which the molecular weight of the flocculent is between about 1 to 30 million.

22. The method of claim 1, in which the water component contains between about 0.1 to about 2% solids.

23. The method as in any of claims 1 or 22, in which the water component is further treated with a flocculent to separate solids from the water in order to make the water potable.

24. The method as in any of claims 1 or 13, further comprising a compressing device to remove water from the solids exiting the non compressing separation device.

25. The method of claim 24 in which said compressing device is a roll press.

26. The method of claim 1, in which the solids suspension entering the non compressing device contains about 0.5 to about 30% solids.

27. The method as in any of claims 1 or 26, in which the solids suspension entering the non compressing device contains about 1 to about 5% solids.

28. A method of reducing the negative environmental impact related to the application of low solids manure suspension to soils, wherein manure solids are separated from water for application to the soil by:
treating said low solids manure suspension with a coagulant and a flocculent to agglomerate said manure solids and release water;
moving said manure solids continually by a non compressing device away from the water;
separating said water progressively from said manure solids by gravity; and
applying said manure solids to soil for improving soil condition.

29. A method of removing water from a low solids suspension to produce low moisture solids resulting in improved drying efficiency and reducing the cost of drying for the low moisture solids by:
treating said suspension with a coagulant and a flocculent to agglomerate said low moisture solids and release water;
moving said solids continually by a non compressing device away from the water;
separating said water progressively from said low moisture solids by gravity; and
drying the solids to the desired moisture.

30. A cost effective method of solids agglomeration from a colloidal suspension wherein the initial step to agglomeration is to separate the liquids from the solids by:
treating said suspension with a coagulant and a flocculant to agglomerate said solids and release water;
continually moving said solids by a non compressing device away from the water;
allowing said water to progressively release from said solids by gravity; and
processing the solids for their intended use.

31. A method of purifying industrial effluents containing by binding the impure particles into solids and releasing clean water by:
treating said effluents with a coagulant and a flocculent to agglomerate impurities and release water;
continually moving the agglomerated impurities by a non compressing device away from the water;
releasing said water progressively from said impurities by gravity;
collecting and disposing of the impurities; and
using the clean water for industrial purposes.

32. A method of removing colloidal particles containing toxins such as PCB's, dioxins and furans from bodies of water by:
treating said bodies of water with a coagulant and a flocculent to agglomerate said toxins and release water;
continually moving the agglomerated toxins by a non compressing device away from the water;
releasing said water progressively from said toxins by gravity;
collecting and disposing of the toxins; and
using the clean water for industrial purposes.

33. A composition for continuously agglomerating colloidal fines into solid material comprising a flocculant.

34. A composition for continuously agglomerating colloidal fines into solid material comprising a coagulant and a flocculent.

35. The composition as in any of claims 33 or 34, in which said flocculant is selected from the group consisting of:
Acrylamide/acryloylethyltrimethylammoniumchloride;
3-chloro-2-hydroxypropyltrimethylammonium chloride modified starch;
Acrylamide/acrylamidopropyltrimethylammonium chloride, Acrylamide/sodium acrylate and the sodium salt of Acrylamide/2-acrylamidomethylpropanesulfonic acid or combinations thereof.

36. The composition of claim 34, wherein said coagulant is selected from the group consisting of:
Aluminum Chlorohydrate, Aluminum sulfate, Aluminum Perchloride, Ferric Chloride, Polyamine, PolyDADMAC, Calcium Chloride, Calcium Nitrate, Calcium Sulfate, Magnesium Chloride, Magnesium Nitrate, Magnesium Sulfate, Aluminum Chloride, Aluminum Nitrate, Calcium Oxide, Magnesium Oxide, Aluminum Oxide and Ferric Oxide, or combinations thereof.

37. A composition as in any of claims 33 or 34, wherein the application of said composition is for the purpose of binding colloidal fines of solids suspensions comprising of organic waste bi-product materials.

38. The composition of claim 37, wherein the bi-product materials include cellulose, bio-ethanol, sugar cane, grain distilled ethanol, switch grass, and combinations thereof.

39. A composition as in any of claims 33 or 34, in which the colloidal fines are dissolved in a liquid suspension comprising about 0.5% to about 30% solids.

40. The composition of claim 34, wherein the coagulant is added in the amount of about 1 to about 100 mg/liter of the liquid suspension to be treated.

41. The composition as in any of claims 33, or 34, in which the flocculent is added in the amount of about 5 to about 75 mg/liter of liquid suspension to be treated.

42. The composition as in any of claims 34, 36, or 38, wherein the bi-product material is grain distilled ethanol, the coagulant is Calcium Oxide, and the flocculent is a polyacrylamide copolymer having a molecular weight between 18 million and 20 million and a charge between 25% and 35%.

43. The method of claim 1 further comprising:
treating said water component with a secondary water treatment method for further water clarification.

44. The method of claim 1 further comprising:
correcting pH of said water by adding an additive.

45. A method of treating dirty or contaminated water comprising:
treating said bodies of water with a coagulant and a flocculent to agglomerate said contaminants and release water;
continually moving said agglomerated contaminants by a non-compressing device away from said water;
releasing said water progressively from said contaminants by gravity;
collecting and disposing of said contaminants;
returning said clean water to said body of water.

46. The method of claim 1 wherein said solids suspension comprises municipal sewage sludge.
